(19) United States
(12) Patent Application Publication
(10) Pub. No.: US 2020/0038884 A1
(43) Pub. Date: Feb. 6, 2020

(54) Fluidic Component

(71) Applicant: FDX Fluid Dynamix GmbH, Berlin (DE)

(72) Inventors: Jens Wintering, Berlin (DE); Bernhard Bobusch, Berlin (DE); Oliver Krüger, Berlin (DE)

(21) Appl. No.: 16/339,039

(22) PCT Filed: Oct. 5, 2017
(86) PCT No.: PCT/EP2017/075383

§ 371 Date: Apr. 3, 2019

(30) Foreign Application Priority Data
Oct. 6, 2016 (DE) 10 2016 219 427.5

(51) Int. Cl. B05B 1/08; B05B 1/04

(52) U.S. Cl. CPC B05B 1/08; B05B 3/16; B05B 1/042

(57) ABSTRACT

A fluidic component for generating a free jet includes a flow chamber that can be traversed by a fluid stream which enters the flow chamber through an inlet opening and exits from the flow chamber through an outlet opening and whose flow direction extends substantially parallel to the main direction of extension of the flow chamber. Within the flow chamber, a main flow channel and secondary flow channels are arranged. The cross-sectional profile of the main flow channel is divergent or sectionally divergent and sectionally convergent along the entire length of the main flow channel in the direction of the main direction of extension of the flow chamber.

The invention relates to a fluidic component according to claim 1, a fluidic component according to claim 15, an appliance that comprises such a fluidic component with the features of claim 29.

The fluidic component is provided to produce a moving fluid jet. Examples for such fluid flow patterns include jet oscillations, rectangular, sawtooth-shaped or triangular jet paths, spatial or temporal jet pulsations and switching operations. Oscillating fluid jets are used to for example uniformly distribute a fluid jet (or fluid stream) on a target area. The fluid stream can be a liquid stream, a gas stream or a multi-phase stream (for example wet steam).

For producing a moving fluid jet fluidic components are known from the prior art, for example from U.S. Pat. No. 8,702,020 B2. These fluidic components so far have been used without a significant divergent fraction, as the jet quality from the outlet of the component plays no role e.g. for flow control. In addition the oscillation angle, also known as spray angle, so far has been limited to an angle of less than 60°, and the time course of the jet which is responsible for the fluid distribution also plays a subordinate role.

The invention thus relates to fluidic components that have an increased jet quality and/or generate a larger oscillation angle and/or have a more uniform fluid distribution. This is achieved on the one hand by a divergent fraction for increasing the jet quality and/or on the other hand for influencing the spray angle. In addition, the invention also provides for an oscillation angle of more than 60° up to 160°. Jet quality here refers to a compact oscillating fluid jet as long as possible. Up to now, it has been attempted to make the exiting fluid jet burst as quickly as possible in order to thus generate a spray angle as large as possible or generate droplets as small as possible, as it is carried out for example by means of disturbing elements in the flow guidance, as it is known from U.S. Pat. No. 5,035,361 A.

For generating a movable fluid stream (or fluid jet) fluidic components furthermore are known. The fluidic components comprise no movable components that serve to generate a movable fluid stream. As compared to the previously known nozzles, they therefore do not have the disadvantages resulting from the movable components.

It is the object underlying the present invention to create a fluidic component that is configured to generate a movable fluid jet preferably with a high spray angle.

These fluidic components can be used in different appliances in which nozzles have been employed so far. Typical appliances are used in agriculture e.g. in spraying devices for liquid fertilizer or for example for plant protection products or also for irrigation systems. Further typical appliances in which the fluidic components are used include cleaning devices or systems, such as rinsing devices, dishwashing machines, belt transport rinsing devices, industrial parts cleaning systems, flushing devices, high-pressure, medium-pressure and low-pressure cleaning devices, floor cleaning devices, car wash facilities, tank cleaning facilities, steam cleaning devices, CO₂ cleaning devices or also snow jet cleaning devices or generally appliance washing systems or also windscreen cleaning devices, devices for cleaning measuring instruments, illumination systems or measurement sensors. Other types of appliance in which the fluidic components are used include appliances in which a uniform distribution of fluid is necessary, such as in electroplating, in glue distribution devices, fluid wetting devices or other appliances in the industrial production and process technology or in the food industry. These components are also employed in the sanitary sector. Typical examples include shower heads, whirlpool, massage nozzles or integrated into the faucet or as a faucet attachment, e.g. as a lettuce shower. Additional fields of application where these nozzles are integrated into appliances include mixing devices, refrigerators or heaters. But the fluidic components are also useful for reducing the temperature stratification, such as in the cooling of components or in air-conditioning. The invention in particular is useful in appliances for fire-fighting due to the integration of the fluidic components in fire-fighting equipment, such as sprinkler systems or fire extinguishing systems.

Due to the wide field of application very different requirements are obtained for the fluidic components. Depending on the requirement, different inlet pressures or volume flows are available for the components. The advantage of these components as compared to conventional nozzles consists in that the same have a relatively constant spray angle α over a large process window. Therefore, the spray angle α substantially is necessary for the design and description of the nozzle. Depending on the application, fluidic components with a spray angle of 5° to 160° are required. To produce this desired angle, the inner geometry parameters must be adapted correspondingly. In this document, the geometrical quantities therefore are expressed in dependence on the desired spray angle α.

The object is achieved by a fluidic component with the features of claim 1.

The fluidic component serves to generate a free jet, wherein the component includes a flow chamber, which can be traversed by a fluid stream that enters into the flow chamber through an inlet opening and exits from the flow chamber through an outlet opening, and whose flow direction extends substantially parallel to the main direction of extension of the flow chamber, and wherein a main flow channel and secondary flow channels are arranged within the flow chamber. Such fluidic components are known in principle from the prior art.

In the fluidic component claimed here the cross-sectional profile of the main flow channel is divergent or sectionally divergent and sectionally convergent along the entire length of the main flow channel in the direction of the main direction of extension.

The object is achieved by a fluidic component with the features of claim 15.

The fluidic component known in principle additionally includes an exit region, in particular a channel or a region, downstream of the outlet opening, which is free from an obstruction.

Advantageous embodiments are subject-matter of the dependent claims.

Exemplary embodiments will be explained with reference to the Figures.

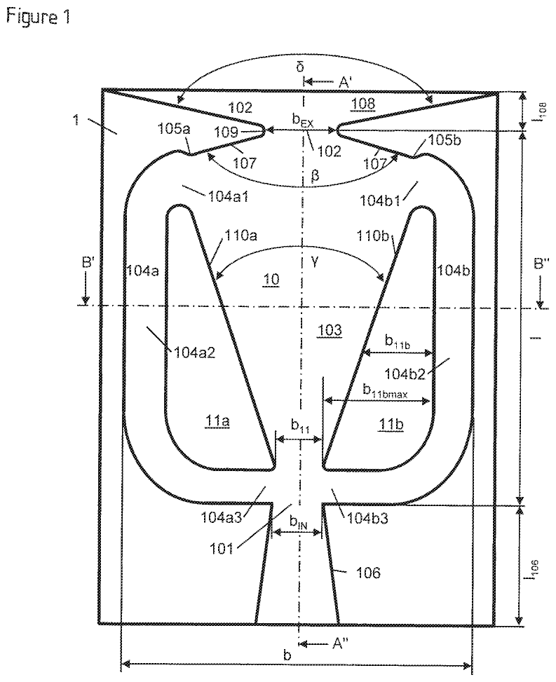

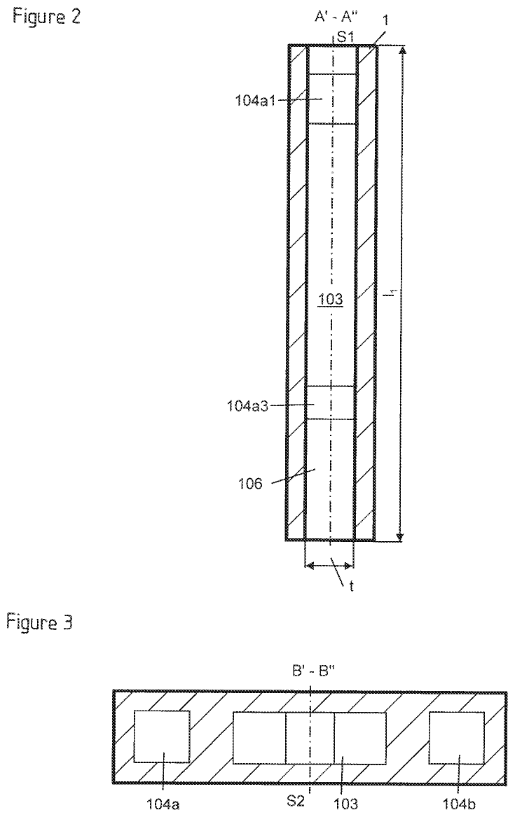

FIG. 1 schematically shows a fluidic component 1 according to an embodiment of the invention. FIGS. 2 and 3 show sectional representations of this fluidic component 1 along lines A′-A″ or B′-B″. The fluidic component 1 comprises a flow chamber 10 that can be traversed by a fluid stream 2. The flow chamber 10 also is known as an interaction chamber.

The flow chamber 10 comprises an inlet opening 101 with an inlet width b_{IN}, via which the fluid stream 2 enters the flow chamber 10, and an outlet opening 102 with an outlet width b_{EX}, via which the fluid stream 2 exits from the flow chamber 10. The outlet width b_{EX} is greater than the inlet width b_{IN}.

The inlet opening 101 and the outlet opening 102 are arranged on two fluidically opposite sides of the fluidic component 1. In the flow chamber 10 the fluid stream 2 substantially moves along a longitudinal axis A of the fluidic component 1 (which connects the inlet opening 101 and the outlet opening 102 to each other) from the inlet opening 101 to the outlet opening 102.

In this design variant, the longitudinal axis A forms an axis of symmetry of the fluidic component 1. The longitudinal axis A lies in two mutually perpendicular planes of symmetry S1 and S2, with respect to which the fluidic component 1 is mirror-symmetrical. Alternatively, the fluidic component 1 cannot be of symmetrical (mirror-symmetrical) design.

For the targeted change in direction of the fluid stream, the flow chamber 10 comprises two secondary flow channels 104a, 104b beside a main flow channel 103, wherein the main flow channel 103 is arranged between the two secondary flow channels 104a, 104b (as seen transversely to the longitudinal axis A). Directly behind the inlet opening 101 the flow chamber 10 splits into the main flow channel 103 and the two secondary flow channels 104a, 104b, which then are joined again directly before the outlet opening 102.

The two secondary flow channels 104a, 104b are arranged symmetrically with respect to the axis of symmetry S2 (FIG. 3). According to a non-illustrated alternative, the secondary flow channels are not arranged symmetrically. The secondary flow channels can also be positioned outside the illustrated flow plane. These channels can be realized for example by means of hoses outside the plane that is formed by S1 or extend through channels that are located at an angle to the flow plane.

The main flow channel 103 substantially linearly connects the inlet opening 101 and the outlet opening 102 to each other so that the fluid stream 2 flows substantially along the longitudinal axis A of the fluidic component 1. Proceeding from the inlet opening 101, the secondary flow channels 104a, 104b in a first portion each initially extend in opposite directions at an angle of substantially 90° with respect to the longitudinal axis A. Subsequently, the secondary flow channels 104a, 104b turn off so that they each extend (second portion) substantially parallel to the longitudinal axis A (in the direction of the outlet opening 102). To again join the secondary flow channels 104a, 104b and the main flow channel 103, the secondary flow channels 104a, 104b at the end of the second portion again change their direction so that they are each directed substantially in the direction of the longitudinal axis A (third portion). In the embodiment of FIG. 1, the direction of the secondary flow channels 104a, 104b changes by an angle of about 120° on transition from the second into the third portion. However, for the change in direction other angles than the one mentioned here can also be chosen between these two portions of the secondary flow channels 104a, 104b.

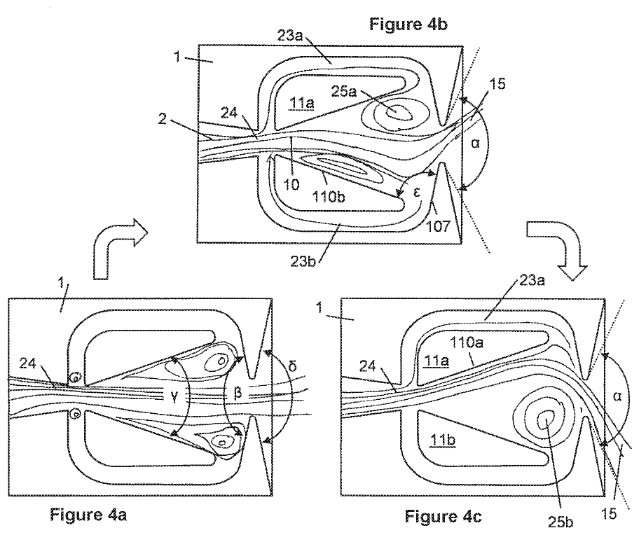

The secondary flow channels 104a, 104b are a means for influencing the direction of the fluid stream 2 that flows through the flow chamber 10. The secondary flow channels 104a, 104b therefor each include an inlet 104a1, 104b1 that is formed by the end of the secondary flow channels 104a, 104b facing the outlet opening 102, and each an outlet 104a3, 104b3 that is formed by the end of the secondary flow channels 104a, 104b facing the inlet opening 101. Through the inlets 104a1, 104b1 a small part of the fluid stream 2, the secondary streams 23a, 23b (FIG. 4), flows into the secondary flow channels 104a, 104b. The remaining part of the fluid stream 2 (the so-called main stream 24) exits from the fluidic component 1 via the outlet opening 102 (FIG. 4). At the outlets 104a3, 104b3 the secondary streams 23a, 23b exit from the secondary flow channels 104a, 104b, where they can exert a lateral (transversely to the longitudinal axis A) impulse on the fluid stream 2 entering through the inlet opening 101. The direction of the fluid stream 2 is influenced such that the fluid main stream 24 exiting at the outlet opening 102 spatially oscillates, namely in the plane in which the main flow channel 103 and the secondary flow channels 104a, 104b are arranged. The plane in which the main stream 24 oscillates corresponds to the plane of symmetry S1 or is parallel to the plane of symmetry S1. FIG. 4, which shows the oscillating fluid stream 2, will be explained in detail later on.

The secondary flow channels 104a, 104b each have a cross-sectional area that is almost constant along the entire length (from the inlet 104a1, 104b1 to the outlet 104a2, 104b2) of the secondary flow channels 104a, 104b. On the other hand, the size of the cross-sectional area of the main flow channel 103 substantially steadily increases in the flow direction of the main stream 23 (i.e. in the direction from the inlet opening 101 to the outlet opening 102), wherein the shape of the main flow channel 103 is mirror-symmetrical to the planes of symmetry S1 and S2.

The main flow channel 103 can taper in downstream direction between the inner blocks 11a, 11b. But to achieve an oscillation angle α of greater than 60° and in particular above 80°, a monotonously divergent shape between the inner blocks 11a and 11b of the main flow channel 103 is advantageous. Alternatively or in addition, it is advantageous that no fittings are present in the vicinity of the outlet 102 in order to thus achieve a high jet quality. From the prior art, solutions are known in which disturbing bodies are positioned in the vicinity of the outlet in order to increase the spray angle by making the same burst. These fittings have the disadvantage that the jet quality of the oscillating free jet 15 (cf. FIG. 4) then is reduced.

The main flow channel 103 is separated from each secondary flow channel 104a, 104b by a block 11a or by the block 11b. In the embodiment, the two blocks 11a, 11 b are arranged symmetrically with respect to the mirror plane S2. In principle, however, they can also be formed differently and be aligned non-symmetrically. In the case of a non-symmetrical alignment the shape of the main flow channel 103 also is non-symmetrical with respect to the mirror plane S2. The shape of the blocks 11a, 11b, which is shown in FIG. 1, only is an example and can be varied. The blocks 11a, 11b of FIG. 1 have rounded edges. Sharp-edged edges are also possible. In this design variant, however, the blocks 11a, 11 b are configured such that a triangular or wedge-shaped flow chamber 103 is formed thereby. The shape of the flow chamber chiefly is formed by the inwardly pointing surfaces of the blocks 11a, 11 b and here is designated by the numeral 110. The angle included by the surfaces here is referred to as γ. Moreover, the surface 110 that is formed by the line shown in the Figure and the component depth t can have a slight curvature or be formed by one or more radii, a polynomial and/or one or more straight lines or by a mixed form. To achieve a large spray angle α greater than 60°, in particular greater than 80°, it is advantageous when in terms of shape care is taken that the width b₁₀₃ of the main flow channel 103 increases monotonously in downstream direction between the inner blocks 11a, 11b. When no large spray angle α is desired, a shape of the main flow channel 103 non-broadening in places is advantageous.

At the inlet 104a1, 104b1 of the secondary flow channels 104a, 104b there are also provided separators 105a, 105b in the form of indentations. At the inlet 104a1, 104b1 of each secondary flow channel 104a, 104b an indentation 105a, 105b each protrudes beyond a portion of the circumferential edge of the secondary flow channel 104a, 104b into the respective secondary flow channel 104a, 104b and at this point changes its cross-sectional shape by reducing the cross-sectional area. In the embodiment of FIG. 1 the portion of the circumferential edge is chosen such that each indentation 105a, 105b (among other things also) is directed to the inlet opening 101 (aligned substantially parallel to the longitudinal axis A). Alternatively, the separators 105a, 105b can be oriented differently. The separation of the secondary streams 23a, 23b from the main stream 24 is influenced and controlled by the separators 105a 105b. By the shape, size and orientation of the separators 105a, 105b the quantity that flows from the fluid stream 2 into the secondary flow channels 104a, 104b as well as the direction of the secondary streams 23a, 23b can be influenced. This in turn leads to an influence on the exit angle of the main stream 24 at the outlet opening 102 of the fluidic component 1 (and hence to an influence on the oscillation angle α) as well as the frequency at which the main stream 24 oscillates at the outlet opening 102. By choosing the size, orientation and/or shape of the separators 105a, 105b the profile of the main stream 24 exiting at the outlet opening 102 thus can be influenced in a targeted way. Alternatively, a separator can also be provided only at the inlet of one of the two secondary flow channels. What is particularly advantageous is the position of the separators 105a, 105b above the maximum width b₁₁ₐₘₐₓ, b_{11bmax}.

Upstream of the inlet opening 101 of the flow chamber 10 a funnel-shaped attachment 106 is provided, which tapers in the direction of the inlet opening 101 (in downstream direction). The flow chamber 10 also tapers, namely in the region of the outlet opening 102 downstream from the inner blocks 11a, 11b. The taper is formed by an outlet channel 107 that extends between the separators 105a, 105b and the outlet opening 102. In components without separators 105a, 105b the outlet channel 107 starts at the secondary flow channel inlet 104a1, 104b1. The funnel-shaped attachment 106 and the outlet channel 107 taper such that only their width, i.e. their expansion in the plane of symmetry S1 perpendicularly to the longitudinal axis A, each decreases in downstream direction. The taper has no influence on the depth, i.e. the expansion in the plane of symmetry S2 perpendicularly to the longitudinal axis A of the attachment 106 and of the outlet channel 107 (FIG. 2). Alternatively, the attachment 106 and the outlet channel 107 also can each taper in its width and depth. Furthermore, only the attachment 106 can taper in its depth or width, while the outlet channel 107 tapers both in its width and in its depth, and vice versa. The extent of the taper of the outlet channel 107 influences the directional characteristic of the fluid stream 2 exiting from the outlet opening 102 and thus its oscillation angle α. In FIG. 1, the shape of the funnel-shaped attachment 106 and the outlet channel 107 only are shown by way of example. Here, their width each decreases linearly in downstream direction. Other shapes of the taper are possible. In this embodiment, the length of the funnel-shaped attachment l₁₀₆ at least corresponds to the inlet width b_{IN}, hence l₁₀₆>b_{IN}.

The inlet opening 101 and the outlet opening 102 each have a rectangular cross-sectional area. The same each have the same depth (expansion in the plane of symmetry S2 perpendicularly to the longitudinal axis A, FIG. 2), but differ in their width b_{IN}, b_{EX} (expansion in the plane of symmetry S1 perpendicularly to the longitudinal axis A, FIG. 1). In particular, the outlet opening 102 is broader than the inlet opening 101.

The outlet width b_{EX} is greater than the narrowest cross-sectional constriction upstream of the flow chamber. The narrowest cross-sectional constriction can be either the minimum width of the flow chamber b₁₁ or the inlet width b_{IN}. Typically, both length dimensions lie in a range between 0.01 mm and 250 mm. These geometrical dimensions depend on the required volume flow and on the constraint as to how much fluid should flow through the component. Therefore, no more limiting dimensions can be indicated here. However, said dimensions can deviate from the indicated dimensions. Typically, the difference between the width b_{IN} and b₁₁ is not more than 40%. This means that the width b₁₁ can be greater or smaller than the width b_{IN} by up to 40%. What is preferred is the combination that the width b₁₁ is smaller than or equal to the width b_{IN}.

For connecting the exit region 108 to the functional geometry two variants are advantageous.

On the one hand with a radius 109 that is smaller than the minimum width of b_{IN} or b₁₁. An extreme value by which a sharp-edged outlet 102 is obtained is a radius of zero.

Due to the higher mechanical stability, a radius 109 is to be preferred. The radius is followed by an almost linear portion. This almost linear or linear portion can also be formed by a polynomial and includes an angle δ.

This angle δ can have different dimensions. What is advantageous is an angle δ derived from the desired oscillation angle α. A deviation of +12° and −40° from the oscillation angle is possible, hence α−40°<δ<α+12°. A particularly preferred deviation is +7° and −30°, hence α−30°<δ<α+7°. In case the freely oscillating oscillation angle α is too large, the oscillation angle α thereby can be reduced to the angle δ by a smaller angle δ.

The angle δ can, however, also be used to increase the spray angle α in case the freely oscillating oscillation angle α is not sufficient. Then, the spray angle can be increased by up to 12° when the angle δ is dimensioned larger than the oscillation angle α by this maximum of 12°. In particular, an increase of the angle δ by a maximum of 4° is preferred for the freely oscillating exiting free jet 15.

For some applications, in particular in those where a more uniform distribution is desired, it is advantageous when the almost linear portions after the radius 109 do not touch the oscillating free jet 15, as is shown by way of example in FIG. 4 c). Then, the angle δ should be chosen considerably larger than the oscillation angle α, for example 180°.

The length of the outlet region l₁₀₈ positively influences the jet quality of the oscillating fluid jet. The longer the length of the exit region l₁₀₈, the more strongly the exiting fluid jet is bundled. At a desired increased fluid jet quality, a length l₁₀₈ of at least half the radius 109 is necessary. It is particularly preferred when l₁₀₈ at least corresponds to the outlet width b_{EX}. The maximum length l₁₀₈ corresponds to the component length l.

FIG. 4 shows three snapshots of a fluid stream 2 to illustrate the flow direction (streamlines) of the fluid stream 2 in a fluidic component 1 during an oscillation cycle (images a) to c)). The fluidic component 1 of FIG. 4 differs from the fluidic component 1 of FIGS. 1 to 3 in particular by the fact that no separators 105 are provided. The component length l of the fluidic component 1 of FIG. 4 is 22 mm and the component width b=20 mm. The width b_{IN} of the inlet opening 101 is 3.2 mm and the width b₁₁ is 2.8 mm. The outlet width b_{EX} is 5 mm. In this exemplary embodiment, the component depth t is constant and amounts to 2 mm. The main flow channel 103 has a maximum width b₁₀₃ₘₐₓ of 13.07 mm between the blocks 11a, 11b. In this exemplary embodiment, this maximum width b₁₀₃ₘₐₓ here is defined at the position from which the radius transitions to the straight line from the inner block surface 110. At the inlet opening 101 the fluid flowing through the fluidic component 1 has a pressure of 0.11 bar and a volume flow of 1.5 l/min, wherein the fluid is water having a temperature of 20° C. However, the illustrated fluidic component 1 in principle is also suitable for gaseous fluids.

In the images a) and c) the streamlines are shown for two deflections of the exiting main stream 24, which approximately correspond to the maximum deflections. The angle swept by the exiting main stream 24 between these two maxima is the oscillation angle α. Image b) shows the streamlines for a position of the exiting main stream 24, which approximately lies in the middle between the two maxima of images a) and c). In the following, the flows within the fluidic component 1 during an oscillation cycle will be described.

By introducing a one-time accidental or targeted disturbance, the fluid stream 2 is deflected laterally in the direction of the side wall 110a of the one block 11a facing the main flow channel 103, so that the direction of the fluid stream 2 increasingly deviates from the longitudinal axis A, until the fluid stream is maximally deflected. Due to the so-called Coandă effect, the largest part of the fluid stream 2, the so-called main stream 24, attaches to the side wall of the one block 11b and then flows along this side wall 110b. In conjunction with the angle δ, the angle γ later on determines the oscillation angle α. Depending on the constraints or the field of use of the fluidic component 1, the angle γ varies correspondingly. The inside 110 of the main flow channel 103 and the inside of the outlet channel 107 are positioned at the angle E to each other. In the illustrated embodiment, the angle E is approximately 90°. In other embodiments, the angle E can lie in the range between 80° and 110°. The angle γ and the angle δ thereby are directly related when fluidic components with a large spray angle of at least 60° are used. Due to the non-linear behavior of the flow, a detailed indication is not practicable here.

In the region between the main flow 24 and the other block 11a a recirculation area 25a is formed. The recirculation area 25a grows, the more the main stream 24 attaches to the side wall of the one block 11b. The main stream 24 exits from the outlet opening 102 at an angle changing over time with respect to the longitudinal axis A. In FIG. 4c) the main stream 24 attaches to the side wall of the one block 11a and the recirculation area 25b has its maximum size. In addition, the main stream 24 exits from the outlet opening 102 with approximately the largest possible deflection.

A small part of the fluid stream 2, the so-called secondary stream 23a, 23b, separates from the main stream 24 and flows into the secondary flow channels 104a, 104b via their inlets 104a1, 104b1. In the situation shown in FIG. 4c) the part of the fluid stream 2 that flows into the secondary flow channel 104b adjoining the block 11b to whose side wall the main stream 103 does not attach, is distinctly larger (due to the deflection of the fluid stream 2 in the direction of the block 11a) than the part of the fluid stream 2 that flows into the secondary flow channel 104a adjoining the block 11a, to whose side wall the main stream 103 attaches. In FIG. 4c) the secondary stream 23b hence is distinctly larger than the secondary stream 23a, which is almost negligible. In general, the deflection of the fluid stream 2 into the secondary flow channels 104a, 104b can be influenced and controlled by means of separators. The secondary streams 23a, 23b (in particular the secondary stream 23b) flow through the secondary flow channels 104a or 104b to the respective outlets 104a2, 104b2 and hence impart an impulse to the fluid stream 2 entering the inlet opening 101. As the secondary stream 23b is larger than the secondary stream 23a, the impulse component resulting from the secondary stream 23a prevails.

The main stream 24 hence is urged against the side wall of the block 11a due to the impulse (of the secondary stream 23b). At the same time, the recirculation area 25b moves in the direction of the inlet 104b1 of secondary flow channel 104b, whereby the supply of fluid into the secondary flow channel 104b is disturbed. The impulse component resulting from the secondary stream 23b hence decreases. At the same time, the recirculation area 25b is reduced in size, while a further (growing) recirculation area 25a is formed between the main stream 24 and the side wall of the block 11a. The supply of fluid into the secondary flow channel 104a also increases. The impulse component resulting from the secondary stream 23a hence increases. The impulse components of the secondary streams 23a, 23b in the further course approach each other more and more, until they are of equal size and cancel each other out. In this situation the entering fluid stream 2 is not deflected (image a)), so that the main stream 24 moves approximately centrally between the two blocks 11a, 11b and exits from the outlet opening 102 without deflection.

In the further course, the supply of fluid into the secondary flow channel 104a increases more and more, so that the impulse component resulting from the secondary stream 23a exceeds the impulse component resulting from the secondary stream 23b. The main stream 24 thereby is urged away from the side wall of the block 11a more and more, until it attaches to the side wall of the opposed block 11b due to the Coandă effect (FIG. 4c)). The recirculation area 25b disappears, while the recirculation area 25a grows to its maximum size. The main stream 24 now exits from the outlet opening 102 with maximum deflection, which as compared to the situation of FIG. 4b) has an inverse sign.

Subsequently, the recirculation area 25a will travel and block the inlet 104a1 of the secondary flow channel 104a, so that the supply of fluid here decreases again. In the following, the secondary stream 23b will provide the dominant impulse component so that the main stream 24 again is urged away from the side wall of the block 11b. The described changes now take place in reverse order.

Due to the process described above, the main stream 24 exiting at the outlet opening 102 oscillates about the longitudinal axis A in a plane in which the main flow channel 103 and the secondary flow channels 104a, 104b are arranged, so that a fluid jet sweeping to and from is generated. To achieve the described effect, a symmetrical construction of the fluidic component 1 is not absolutely necessary.

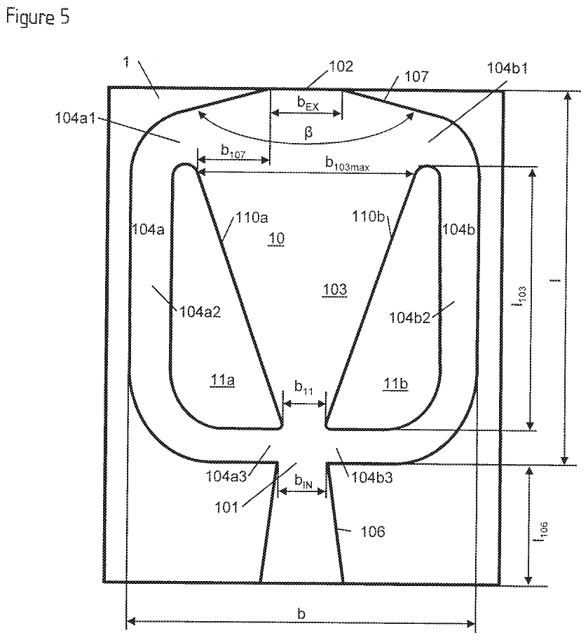

FIG. 5 shows a fluidic component 1 without flow separator 105. In addition, the narrowest cross-section between the inner blocks 11a, 11b here is located at the width b₁₁. This component also has no radius 109 or an infinitely small radius at the outlet 102. With reference to this component, important relationships of the geometrical features are illustrated by way of example, which are required to generate large spray angles α greater than 60°, in particular greater than 80°.

The angle δ is to be chosen equal to or greater than the desired oscillation angle α. Preferably, the angle δ is greater than the desired oscillation angle α. The angle δ can be greater than the achievable oscillation angle α by up to 70%.

The length of the flow chamber l₁₀₃ is equal to or preferably greater than the maximum width of the flow chamber b₁₀₃ₘₐₓ, in particular for fluidic components with an inlet pressure of more than 0.005 bar. To increase the jet quality, an increase of the length l₁₀₈ (cf. FIG. 1) is advantageous. In such fluidic components with an inlet pressure of more than 0.05 bar at the inlet, the length l₁₀₈ should be at least b_{IN}/4. What is preferred particularly is a length l₁₀₈ of at least b_{EX}.

The geometrical dimension b₁₀₇, which is present between the outlet 102 and the inner block 11, is greater than or equal to the smaller dimension of b_{IN} or b₁₁. The length of b₁₀₇ can be greater than the smaller dimension of b_{IN} or b₁₁ by up to 100%. This dimension is dependent on the desired oscillation angle α. The larger the oscillation angle α is to be, the larger the width b₁₀₇ becomes.

The outlet width b_{EX} also is dependent on the desired oscillation angle α. In the embodiment shown here, the outlet width b_{EX} is determined by the following regularity: b_{EX}=min(b₁₁, b_{IN})/[sin(90°−α/2)]±30%. In fluidic components with a flow separator 105 a higher deviation of 45% is possible. Due to the non-linear character of the flow, a more specific indication is not possible here, but can be determined by the skilled person by means of the known flow design tools.

In this component, the width b₁₀₃ₘₐₓ corresponds to the fluidically relevant dimension b_{103above}. The dimension b_{103above} is located in the upper third, i.e. in the last third of the main flow channel 103 localized in downstream direction. This width b_{103above} is measured at the position at which the main flow channel 103 with straight walls transitions into a curvature laterally towards the secondary flow channels 104a, 104b, namely at the turning point of the curved surface. This turning point can also be referred to as arc change. At this point, the direction of the tangent changes from one point to the next. In FIG. 5, these points also mark the maximum longitudinal extension of the main flow channel 103 in the flow chamber 10 in the direction of the outlet opening 102.

For the dimension b_{103above} the following relationship applies: b_{EX}<b_{103above}<3·b_{EX}. This will be the case for example with small radii, i.e. radii smaller than b_{IN}/2, e.g. smaller than 3.5 mm.

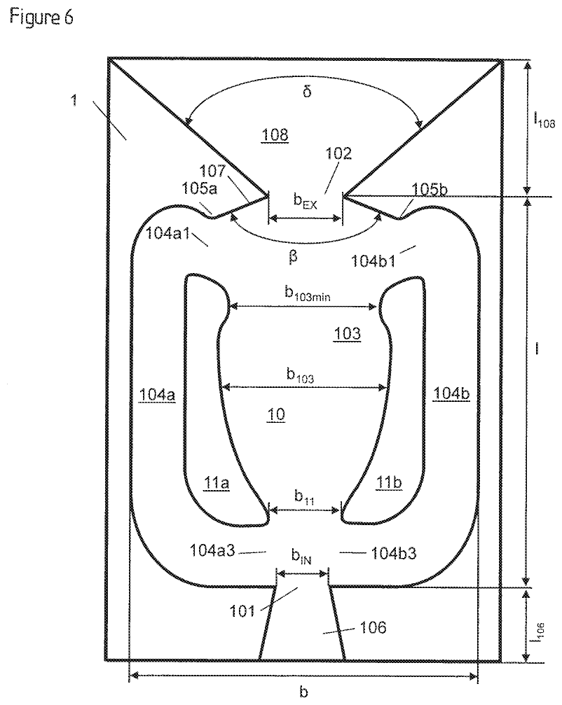

The fluidic component 1 shown in FIG. 6 corresponds to the one of FIG. 1 with the difference that the inner surfaces 110 of the blocks 11 are shaped differently and the exit region 108 is formed considerably longer. Such components with and without exit region 108 are advantageous in particular for cleaning applications or for fluid distribution applications. In the fluidic component 1 shown here, the main flow chamber 103 has a convex shape between the inner blocks 11a, 11b. In upstream direction, the flow chamber 103 is becoming monotonously larger in the first part and in the rear part the flow chamber 103 is narrowed again. The resulting minimum width b₁₀₃ₘᵢₙ of the flow chamber 103 will have the following size: b₁₁<b₁₀₃ₘᵢₙ<3·b_{EX}. Here as well, the width b₁₀₃ₘᵢₙ corresponds to the fluidically relevant width b_{103above}. The upper width b_{103above} is determined at the turning point of the inwardly directed shape of the inner blocks 11a, 11b. Like also in the other embodiments, the following relationship b_{EX}<b_{103above}<3·b_{EX} applies here.

In these components, the oscillation mechanism deviates from the oscillation mechanism described in FIG. 4. The difference is that the fluid from the inner block 11b first flows into the secondary flow channel inlet 104a1 and not into the secondary flow channel inlet 104b1.

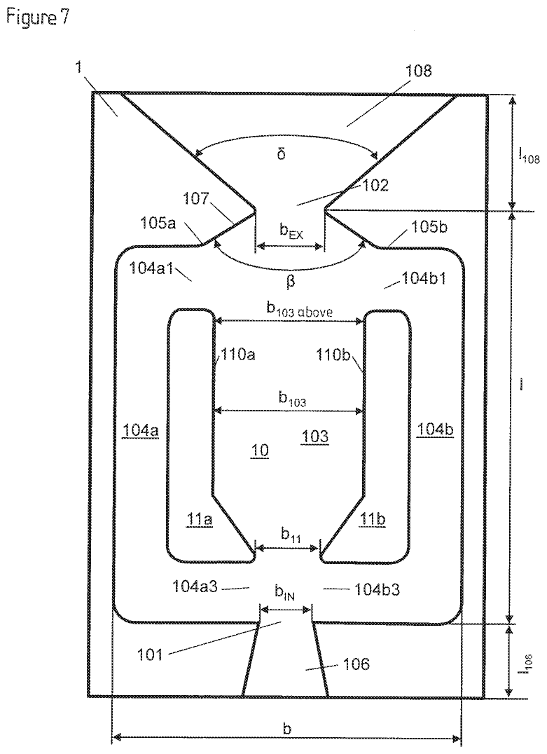

The fluidic component 1 of FIG. 7 differs from the other components in that in the upper two thirds, i.e. in the last two thirds in downstream direction, the flow chamber 103 has an almost constant flow chamber width b₁₀₃. The fluidically relevant width b_{103above} therefore is determined at the position at which the inner surfaces 110a and 110b of the blocks 11a, 11 b pointing into the flow chamber 103 experience a change in direction towards the secondary flow channel inlets 104a1, 104b1, i.e. the turning point. Expressed in other words, the position for determining the fluidically relevant width b_{103above} is determined at the point at which the curvature of the surfaces 110a, 110b abruptly changes to such an extent that at this position the main flow 24 no longer follows the surface. This is the case for example with a change in curvature of at least 3° along a distance of 0.5 mm. In this fluidic component the spray angle α is decisively determined by the angle β.

For connecting the divergent fraction to the flow geometry the two variants known from FIG. 1 are advantageous. For achieving a good spray characteristic, a maximum length of the divergent fraction l₁₀₈ of l₁₀₈<l is preferred. What is particularly preferred is a length l₁₀₈ of b_{EX}<l₁₀₈<l/3.

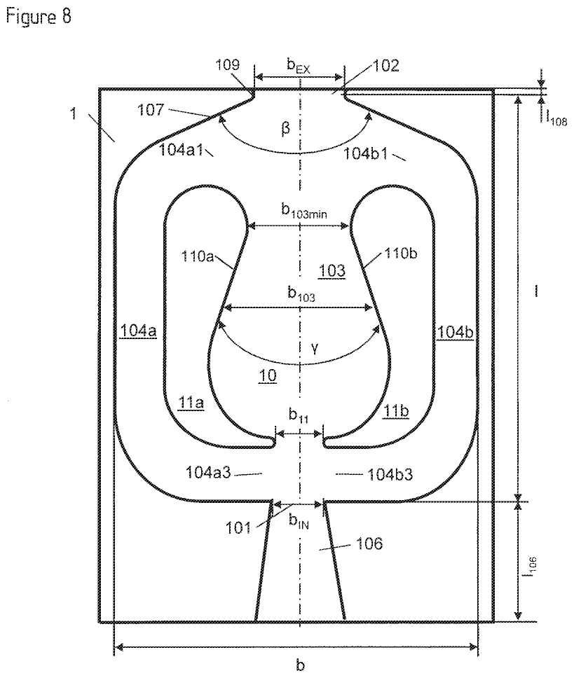

Another design variant of the fluidic component with an exit region 108 is shown in FIG. 8. The design variant of the fluidic component 1 of FIG. 8 differs from the fluidic component of FIG. 6 in that the convex structure is not located in the upper third, i.e. downstream, of the flow chamber 103, but in the lower third of the flow chamber 103. The drop-shaped flow chamber 103 causes a very homogeneous flow distribution. The drop shape is formed by a very strong divergent increase of the flow chamber 103 downstream from the minimum width of the flow chamber b₁₁, in the lower half of the flow chamber followed by a constriction of the flow chamber. An almost linear or piecewise straight surface 110a, 110b is particularly advantageous. These surfaces 110a, 110b include the angle γ.

In contrast to the other components mentioned, the oscillation angle α is determined directly via the angle γ. Therefore, the following relationship α−10°<γ<α+10° applies for the angle γ. In this component, in contrast to the other components, the main stream 24 does not flow through the outlet channel 107, but directly out of the outlet b_{EX}. Therefore, the angle β has no big influence on the oscillation angle α. Just like in the other components, the outlet width b₁₀₃ₘᵢₙ is greater than b_{EX}. Here, the outlet width b₁₀₃ₘᵢₙ corresponds to the uppermost width b_{103above}. It is preferred particularly that the outlet width b_{EX} is greater than the width b₁₀₃ₘᵢₙ plus half of the inlet width b_{IN}, i.e. b_{EX}>b₁₀₃ₘᵢₙ+b_{IN}/2.

1. A fluidic component for generating a free jet, wherein the component includes a flow chamber that can be traversed by a fluid stream which enters the flow chamber through an inlet opening and exits from the flow chamber through an outlet opening and whose flow direction extends substantially parallel to a main direction of extension of the flow chamber, and wherein within the flow chamber a main flow channel and secondary flow channels are arranged,
wherein a cross-sectional profile of the main flow channel is divergent or sectionally divergent and sectionally convergent along an entire length of the main flow channel in the direction of the main direction of extension of the flow chamber.

2. The fluidic component according to claim 1, wherein the divergent fraction of the cross-sectional profile of the flow chamber is monotonous.

3. The fluidic component according to claim 1, wherein the cross-sectional profile of the flow chamber is configured free of kinks.

4. The fluidic component according to claim 1, wherein the flow has a fluidically relevant width which is greater than an outlet width of the outlet opening, wherein the fluidically relevant width is located at the position at which the main flow channel with straight walls transitions into a curvature laterally towards the secondary flow channels.

5. The fluidic component according to claim 1, wherein for generating the free jet with an oscillation angle greater than 60° the walls of the flow chamber are arranged such that the cross-sectional profile of the flow chamber has a monotonously divergent shape along the main direction of extension of the flow chamber, so that the flow chamber includes a triangular or wedge-shaped flow chamber.

6. The fluidic component according to claim 1, wherein an inner side of the main flow channel and the inner side of an outlet channel leading to the outlet opening are positioned at an angle to each other, wherein the angle lies between 80° and 110°.

7. The fluidic component according to claim 1, wherein inner sides of an outlet channel leading to the outlet opening are positioned at an angle that is equal to or greater than the chosen oscillation angle.

8. The fluidic component according to claim 1, wherein a length of the main flow channel is equal to or greater than a maximum width of the main flow channel.

9. The fluidic component according to claim 1, wherein a distance transversely to the flow direction between the outlet and the exit of the inner block is equal to or greater than the smaller dimension of b_{IN} or b₁₁.

10. The fluidic component according to claim 1, wherein an outlet width of the outlet opening is b_{EX}=min(b₁₁, b_{IN})/[sin(90°−α/2)]±30%, wherein in the case of the presence of a flow separator a higher deviation is necessary due to the non-linear behavior of a fluid, and the fluidic component applies b_{EX}=(b₁₁, b_{IN})/[sin(90°−α/2)]±45%.

11. The fluidic component according to claim 1, wherein for an angle included by the inner walls of the inner blocks the fluidic component applies: α−10°<γ<α+10°, with α as an oscillation angle.

12. The fluidic component according to claim 1, wherein for an outlet width b_{EX} the fluidic component applies b_{EX}>b₁₀₃ₘᵢₙ+b_{IN}/2, wherein b₁₀₃ₘᵢₙ is a minimum width of the main flow channel and b_{IN} is an inlet width of the flow chamber.

13. The fluidic component according to claim 1, wherein the main flow channel has a drop shape that is formed by a divergent increase of the flow chamber downstream from a minimum width of the flow chamber in the lower half of the flow chamber followed by a constriction of the flow chamber.

14. The fluidic component according to claim 13, wherein for an angle included by the straight parts of the inner walls of the inner blocks the fluidic component applies: α−10°<γ<α+10°, with α as an oscillation angle.

15. A fluidic component for generating a free jet, wherein the component includes a flow chamber that can be traversed by a fluid stream which enters the flow chamber through an inlet opening and exits from the flow chamber through an outlet opening and whose flow direction extends substantially parallel to the main direction of extension of the flow chamber, wherein within the flow chamber a main flow channel and secondary flow channels are arranged,
wherein an exit region downstream of the outlet opening is free from an obstruction.

16. The fluidic component according to claim 15, wherein in flow direction the exit region is laterally limited by walls that are arranged at an angle (δ), wherein a size of the angle (δ) depends on a predetermined oscillation angle (α): α−40°<δ<α+12°.

17. The fluidic component according to claim 15, wherein in the angle (δ) is greater than the oscillation angle α.

18. The fluidic component according to claim 15, wherein a length of the exit region in flow direction corresponds to at least half of a rounding radius at the outlet of the flow chamber and at the inlet to the exit region or the length of the exit region in flow direction at least corresponds to the outlet width of the flow chamber.

19. The fluidic component according to claim 15, wherein a length of the outlet region in flow direction is at least b_{IN}/4.

20.-28. (canceled)

29. An appliance with at least one of the fluidic components according to claim 1, wherein the appliance comprises a spraying device for water, fertilizer or plant protection products, a cleaning device for dishes, goods or parts, a pressure cleaning device, a car wash facility, a cleaning device for sensors, window panes or surface areas, a fluid distribution device, a sanitary appliance, a fire fighting appliance, in particular a sprinkler system or a fire extinguishing system.
